(19) United States
(12) Patent Application Publication
(10) Pub. No.: US 2009/0132713 A1
(43) Pub. Date: May 21, 2009

(54) SINGLE-ROUNDTRIP EXCHANGE FOR CROSS-DOMAIN DATA ACCESS

(75) Inventors: Sunava Dutta, Seattle, WA (US); Zhenbin Xu, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/942,734

(22) Filed: Nov. 20, 2007

(51) Int. Cl. G06F 15/16

(52) U.S. Cl. 709/227

(57) ABSTRACT

An anonymous cross-domain data request message is sent to a target domain, the request message including a cross-domain data request header. A cross-domain response message is also received from the target domain if cross-domain data requests are supported by the computing device and if the data requested by the anonymous cross-domain data request message is available for cross-domain data requests. The cross-domain response message includes a cross-domain request allowed header as well as the data requested by the anonymous cross-domain data request message. The requested data can be thoroughly examined, without restriction, by a Web page initiating the request. The target domain is a different domain than the domain that includes a Web page that requested that the anonymous cross-domain data request message be sent.

### BACKGROUND

The use of the Internet and the World Wide Web (or simply the Web) by individuals and companies throughout the world has become increasingly common. As use of the Web has grown, aggregating data from multiple different Web sites for display on a single Web page, also referred to as a “mashup”, has become increasingly desirable. The generation of such mashups, however, is currently hindered due to single site origin restrictions that require a Web page in one domain to operate through a proxy server in order to obtain data from another Web page in another domain.

The single site origin restrictions, or same origin policy, in the Web browser dictates that resources from other domains can be mixed into a page, but those cross-domain resources can only be executed by the browser and cannot be read by the calling Web page. For instance, a first Web page can include an image from another domain, but script on the first Web page cannot examine the displayed picture and send information about it back to the servers hosting the Web page. Similarly, this first Web page can include a script from another domain, but cannot examine the source code of that script.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a cross-domain data request message is sent to a target domain. This cross-domain data request message includes a cross-domain data request header. A cross-domain response message is also received from the target domain. This cross-domain response message includes a cross-domain request allowed header as well as the data requested by the cross-domain data request message. The target domain is a different domain than the domain that includes a Web page that requested that the cross-domain data request message be sent.

In accordance with one or more aspects, an anonymous cross-domain data request message is received directly from an application on a client device. This anonymous cross-domain data request message includes a cross-domain data request header. A cross-domain response message is sent to the client device, the cross-domain message including a cross-domain request allowed header as well as the data requested by the anonymous cross-domain data request message. This cross-domain response message is sent to the client device only if cross-domain data requests are supported by the computing device and if the data requested by the anonymous cross-domain data request message is available for cross-domain data requests.

In accordance with one or more aspects, instructions that are included as part of a Web page instantiate a Domain Request object for cross-domain data access. The instructions invoke an Open method of the Domain Request object to identify data to be requested from a first domain that is different than a second domain from which the Web page was obtained. The instructions further invoke a Send method of the Domain Request object to request that a Web browser send a cross-domain data request to a server device hosting the first domain.

### BRIEF DESCRIPTION OF THE DRAWINGS

The same numbers are used throughout the drawings to reference like features.

FIG. 1 illustrates an example system employing the single-roundtrip exchange for cross-domain data access in accordance with one or more embodiments.

FIG. 2 is a flowchart illustrating an example process for obtaining cross-domain data in accordance with one or more embodiments.

FIG. 3 is a flowchart illustrating an example process for responding to cross-domain data requests in accordance with one or more embodiments.

FIG. 4 illustrates an example Domain Request object used in one or more embodiments.

FIG. 5 illustrates an example computing device that can be configured to implement the single-roundtrip exchange for cross-domain data access in accordance with one or more embodiments.

### DETAILED DESCRIPTION

Single-roundtrip exchange for cross-domain data access is discussed herein. A Web browser can display a Web page from one domain and receive a request from that Web page for data that resides in a different domain. The browser sends a cross-domain request to a server in that different domain. If the server supports cross-domain requests, then the server returns a cross-domain response to the browser including the requested data. The data from the different domain can thus be obtained in a single roundtrip exchange between the browser and the server hosting that different domain. The server hosting the Web page being displayed by the browser is not involved in, and need have no knowledge of, this cross-domain data access.

The single-roundtrip exchange for cross-domain data access discussed herein describes a request and response format that allows cross-domain communication. Both the requesting browser and the server hosting the targeted domain opt in to supporting this request and response format, so legacy systems that do not opt in are not adversely affected by this request and response format.

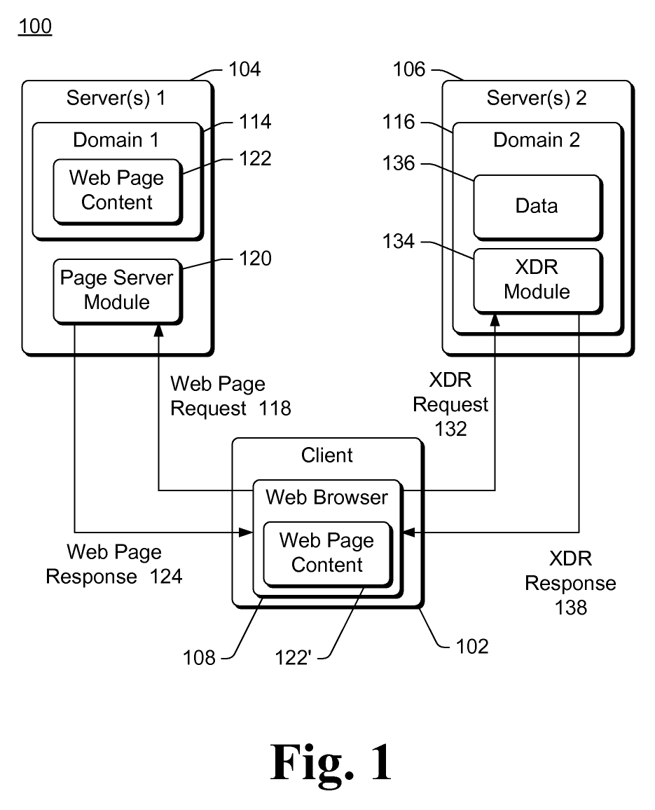

FIG. 1 illustrates an example system 100 employing the single-roundtrip exchange for cross-domain data access in accordance with one or more embodiments. System 100 includes a client device 102, one or more servers 104, and one or more servers 106. Client device 102 includes a Web browser 108. Client device 102 can be any of a variety of different computing devices that can access the Internet such as a desktop computer, a laptop computer, a handheld computer, a gaming console, a cellular phone, an automotive computer, and so forth. During operation, a user of client device 102 interacts with Web browser 108 to request and view different Web pages. Web browser 108 can be any of a variety of different browser applications such as Internet Explorer® available from Microsoft Corporation of Redmond, Wash., Firefox® available from Mozilla Corporation of Mountain View, Calif., Opera available from Opera Software of Oslo, Norway, and so forth.

Web pages on the Internet are organized by domains. Devices that make Web pages available to other devices, also referred to as hosting the Web pages, have an associated address referred to as an IP (Internet Protocol) address. A domain refers to a string of characters that are a more user-friendly representation of the IP address. Names of domains are typically in the format of “x.y.z”, where “x” represents a first string of characters (oftentimes “www”), “y” represents a second string of characters (e.g., “Microsoft”, or “uspto”, and so forth), and “z” represents a third string of characters (e.g., “com”, “net”, “gov”, and so forth). A single domain can include multiple different Web pages. Additionally, it should be noted that a particular domain can be hosted by a single server device or alternatively by multiple server devices.

In system 100, a first domain 114 is hosted by server(s) 104, and a second domain 116 is hosted by server(s) 106. Although illustrated as separate servers 104 and 106, it is to be appreciated that domains 114 and 116 could alternatively be hosted by the same server(s). During operation, Web browser 108 issues a Web page request 118 for a Web page in domain 114. Page server module 120 receives the request and obtains the Web page content 122 for the requested Web page. This Web page content 122 is then returned as part of response 124. The Web page content 122 can include active content, such as a script, which can make a cross-domain data request as discussed in more detail below. The Web page content 122 can also include non-active content or data that describes what is to be presented to the user as the Web page and how it is to be presented. Web browser 108 receives response 124 and displays the requested Web page given the received Web page content 122′ to the user at client device 102.

Web pages displayed by Web browser 108 can include a cross-domain data request. This request is oftentimes included as part of a script or other instructions that are executed as the Web page is displayed, although the request can alternatively be included in the Web page in different manners. The cross-domain data request includes an indication of the data that is being requested as well as a target Web page or domain from which the data is being requested. This indication of the data that is being requested can explicitly identify the data that is being requested (e.g., URL to the data file) or can implicitly identify the data that is being requested (e.g., URL to a program or other component that is to identify the particular data that is to be returned, also referred to as pushing the data to Web browser 108). The request is referred to as a cross-domain request because the request is for data from a different domain than the domain that the Web page is part of.

In response to the cross-domain data request in Web page 122′, Web browser 108 sends a XDR (cross-domain request) request 132 to the target domain, which is target domain 116 in the example of FIG. 1. XDR module 134 receives the request and determines whether cross-domain data requests are supported by domain 116. If cross-domain data requests are supported by domain 116, and the requested data 136 is available for cross-domain data requests, then the data 136 is returned as part of the XDR response 138 to Web browser 108. The returned data can be thoroughly examined by the requesting Web page without restriction. A mashup combining the Web page content 122′ and the received data 136 can then be displayed.

The data returned to Web browser 108 as part of XDR response 138 can be in any of a variety of different forms, such as a Unicode text or byte stream. In one or more embodiments, this data is made available to the requesting Web page via an object property, such as a ResponseText property discussed in more detail below.

As can be seen in FIG. 1, Web browser 108 obtains the cross-domain data directly from the server(s) 106 that hosts the target domain (domain 116). Server(s) 104 is not involved in XDR request 132. Server 104 need have no knowledge of, and typically does not have knowledge of, the XDR request 132 being made by Web browser 108. Thus, server(s) 104 hosting the Web page is not burdened by any cross-domain data requests made by the Web page.

Additionally, the cross-domain data is obtained in a single-roundtrip exchange. This single-roundtrip exchange refers to a request (XDR request 132) and a response (XDR response 138). The cross-domain data can be accessed by sending a single request message and a single response message. Multiple additional requests and responses in order to obtain the desired data are not needed—the requested data can be retrieved with the single-roundtrip exchange. Multiple requests and/or authentication messages being passed between client device 102 and server(s) 106 are not needed for Web browser 108 to obtain the requested cross-domain data.

In one or more embodiments, XDR request 132 is included in a message having a header that identifies the request as a cross-domain data request. Also included in the message is an identifier of server 106 and an identifier of the requested data (data 136). Similarly, XDR response 138 is included in a message having a header that identifies the response as an XDR response, and that further identifies the result of the request. The header can include an indication that the XDR request was allowed, in which case the message also includes the requested data. The header can alternatively include an indication that the XDR request was denied, in which case the message does not include the requested data.

Server(s) 106 receives XDR request 132 and forwards request 132 to the target domain 116. In response to XDR request 132, target domain 116 initially determines whether it supports cross-domain data requests. This determination can be a check that is performed by XDR module 134. For example, domain 116 may generally support cross-domain data requests but this support may be configurable, allowing the support to be enabled and disabled. In such situations, XDR module 134 checks whether cross-domain data requests are currently enabled or disabled. If cross-domain data requests are currently enabled then XDR module 134 determines that domain 116 supports cross-domain data requests. However, if cross-domain data requests are currently disabled then XDR module 134 determines that domain 116 does not support cross-domain data requests.

The determination of whether target domain 116 supports cross-domain data requests can also be performed implicitly. For example, domain 116 may generally not support cross-domain data requests and thus may not include XDR module 134. In such situations, domain 116 receives XDR request 132 but does not understand XDR request 132. Domain 116 sends back a normal HTTP response instead of a XDR response 138. Web browser 108, upon receiving the normal HTTP response, determines that the server does not understand XDR requests because the XDR response 138 was not returned. Web browser 108 thus knows XDR request 132 failed and ignores any data that may have been returned as part of the normal HTTP response. Web browser 108 also returns a failure indication to the Web page that originated the request.

Additionally, when cross-domain data requests are supported by domain 116, not all data included in domain 116 need be available for cross-domain data requests. Domain 116 can include public data as well as private data. Public data refers to data that is available to any requesting party. Private data refers to any data that is typically not available for cross-domain requests. This distinction allows domain 116 to make some data available to other Web pages via the cross-domain data requests while at the same time preventing other data from being accessed by other Web pages via the cross-domain data requests. It should be noted that this private data may be available to Web pages via mechanisms other than the cross-domain data requests discussed herein.

XDR module 134 is configured with an indication of which data in domain 116 is public data and which data is private data, or alternatively is configured with a mechanism to determine which data in domain 116 is public data and which data is private data. For example, XDR module 134 may include a list identifying which data is public data, XDR module 134 may contact another module or component in domain 116 to determine which data is public data, XDR module 134 may access a known location that identifies whether particular data is public, and so forth.

The cross-domain data requests sent by Web browser 108 can be referred to as being anonymous requests because they do not identify a particular client device, web browser, or user of a client device. The cross-domain data requests identify an address associated with Web browser 108 and/or client device 102 so that XDR module 134 knows where to send its response. However, no other information identifying Web browser 108, client device 102, and/or the Web page being displayed by Web browser 108 need be included in the cross-domain data requests. For example, cookies, authentication headers, user name and/or password information, and so forth are not sent to domain 116 as part of the cross-domain data requests. Furthermore, Web browser 108 typically does not verify, authenticate, or otherwise check any identifiers or other authentication information for domain 116, server 106, and/or XDR module 134. Accordingly, the cross-domain data request and response exchange can be referred to as an anonymous exchange.

As discussed above, XDR module 134 determines whether to return the requested data based on whether cross-domain data requests are supported by domain 116 and on whether the requested data is available for cross-domain data requests. XDR module 134 does not verify, authenticate, or otherwise check any identities or identifiers received in XDR request 132 (except any possible authentication information or identifier contained within the URL for personalized data as discussed in more detail below). If cross-domain data requests are supported by domain 116 and the requested data is available for cross-domain data requests then XDR module 134 returns the requested data to any requester.

In one or more embodiments, public data can also include personalized data that can be addressed via URLs in the cross-domain data requests. The URL can contain a one-time token or other information that indicates the requester is authorized to access the personalized data. This one-time token or other information is obtained via other channels outside of the cross-domain data request and response discussed herein. For example, servers 104 and 106 can communicate with one another directly to generate a particular token and/or URL, which can be included in Web page content 122 that is returned to client 102 as part of Web page response 124.

Personalized data is accessed by identifying the personalized data in the URL of a cross-domain data request. No authentication headers, no cookies, and no other fields or headers are used in the cross-domain data request to identify the personalized data or to identify any authorization information. Access to the personalized data is restricted by server 104 and/or server 106 restricting access to the URL. Any requester that obtains the URL identifying the personalized data can retrieve the personalized data from the target domain.

XDR module 134 can also extract information from the URL (such as a token or other information) to be analyzed to determine whether personalized data is to be returned. This analysis can be performed by XDR module 134, or alternatively by another component of server 106 or by another device. For example, a one-time token can be extracted from the URL and compared to a record of tokens maintained by domain 116 to determine whether that token has already been used. If the token has not been used, then the personalized data can be returned; however, if the token has already been used, then the personalized data is not returned. It should be noted, however, that this analysis is performed using the information in the URL of the cross-domain request—no other authentication of the cross-domain data request is performed.

The operation of the Internet and the Web is governed by a wide variety of standards and policies. One such policy is referred to as the same site origin policy. The same site origin policy dictates that when a request for data comes directly from a Web page (via a Web browser), the data is returned to the requester only if the requester is in the same domain as the target of the request. If the requester and the target are in two different domains, then the request typically is passed through another server referred to as a proxy server or mashup server (which is typically the server hosting the requester Web page) operating on behalf of the Web browser.

The single-roundtrip exchange for cross-domain data access discussed herein does not adhere to the same site origin policy. Rather, this data access is designed to circumvent the same site origin policy. The cross-domain data access discussed herein, however, is a protocol that domains and Web browsers can opt into. As discussed above, if a domain does not support cross-domain data requests and does not include an XDR module 134, then cross-domain data requests are not understood by the domain and thus no proper XDR response is returned to the Web browser, and the Web browser will then reject the response even if it contains data. Similarly, if a Web browser does not support cross-domain data requests then any such request attempted by a Web page would not be successful. Rather, such an attempt would fail, be ignored, result in an error, or result in some other action other than the sending of a cross-domain data request. Thus, even though the cross-domain data access discussed herein does not adhere to the same site origin policy, legacy devices that do not support the cross-domain data access discussed herein are not adversely affected by the cross-domain data access discussed herein.

The cross-domain data access discussed herein is a mutual-consent based protocol. Any Web browser and any domain that supports the cross-domain data access discussed herein consents to the circumvention of the same site origin policy when using the cross-domain data requests and responses discussed herein. By sending XDR request 132 and XDR response 138 with the requested data, the Web browser and target domain have mutually consented to circumventing the same site origin policy.

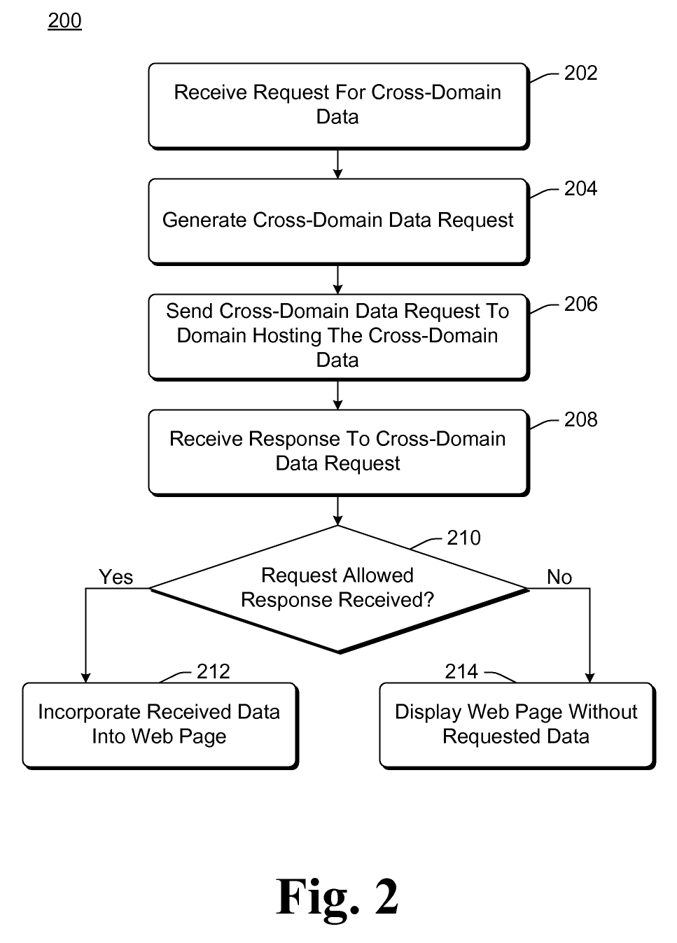

FIG. 2 is a flowchart illustrating an example process 200 for obtaining cross-domain data in accordance with one or more embodiments. Process 200 is carried out by an application of a client device, such as Web browser 108 of FIG. 1, and can be implemented in software, firmware, hardware, or combinations thereof.

Initially, a request for cross-domain data is received (act 202). This request is received from a Web page being displayed or otherwise being accessed. In response to the request, a cross-domain data request is generated (act 204). This cross-domain data request is typically a single message, as discussed above. This cross-domain data request can also be an anonymous request, as discussed above. The cross-domain data request is then sent to the domain hosting the cross-domain data, also referred to as the target domain (act 206). The cross-domain data request is an asynchronous request; the target domain is not guaranteed to respond to the cross-domain data request within a particular amount of time.

Eventually, a response to the cross-domain data request is received (act 208), and a check is made as to whether the response is a request allowed response (act 210). If the response indicates that the cross-domain data request is allowed, then the response includes the requested data and the requested data is incorporated into the Web page requesting the data (act 212). Additionally, the requested data can be thoroughly examined without restriction by the Web page from which the request is received in act 202. This Web page combining the Web page content and the requested data is oftentimes referred to as a mashup. The manner in which the requested data is incorporated into the Web page can vary, and is dependent on the particular Web page. Typically, each Web page includes instructions that incorporate the data or includes information describing how the Web browser is to incorporate the data.

However, if a request allowed response is not received, the Web page is displayed without the requested data (act 214). The request allowed response may not be received for a variety of different reasons, such as an error, the target domain may not support cross-domain data requests, the requested data may not be public data, and so forth. Alternatively, the Web page and/or Web browser may take other actions to attempt to obtain the requested data, such as attempting to obtain the data in a conventional manner via a proxy server.

It should be noted that in one or more embodiments the only response received in act 208 is a request allowed response. If the request is not allowed, then no response is returned by the domain hosting the cross-domain data. In such embodiments, process 200 waits for an amount of time referred to as a timeout. If this amount of time elapses with no request allowed response from the domain hosting the cross-domain data, then process 200 determines in act 210 that a request allowed response is not received.

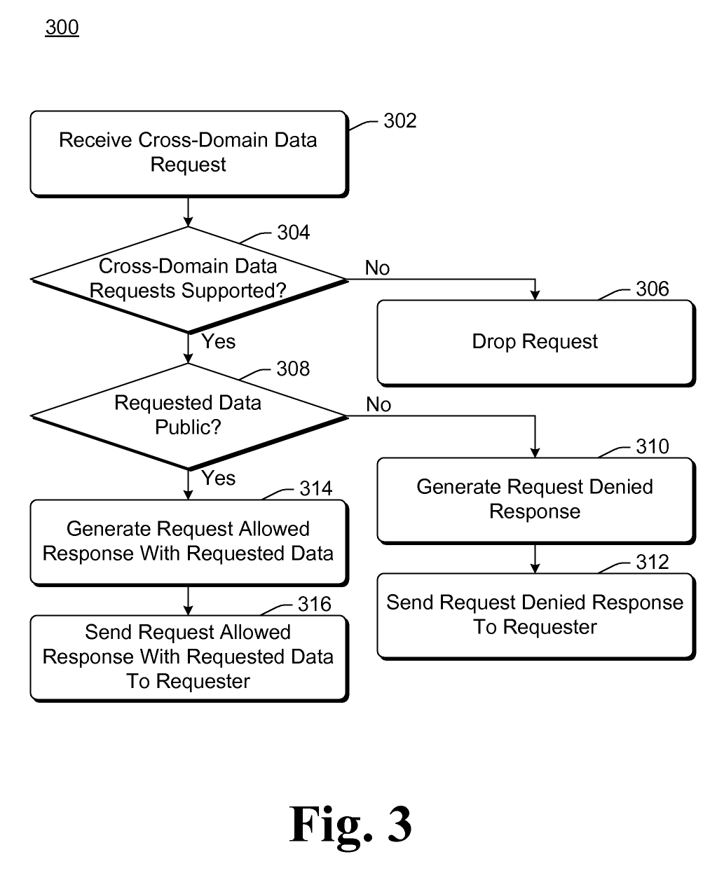

FIG. 3 is a flowchart illustrating an example process 300 for responding to cross-domain data requests in accordance with one or more embodiments. Process 300 is carried out by a component of a server device, such as XDR module 134 of FIG. 1, and can be implemented in software, firmware, hardware, or combinations thereof.

Initially, a cross-domain data request is received (act 302). This request is received directly from an application (such as a Web browser) on a client device as discussed above. It should be noted that various other devices or components (e.g., routers, gateways, etc.) may be involved in routing the request from the client device to the server device that receives the request in act 302, the server device hosting the Web page initiating the cross-domain data request is not operating as a proxy server (mashup server) in making the request received in act 302.

A check is then made as to whether cross-domain data requests are supported (act 304). Cross-domain data requests may not be supported because the target domain of the request does not support cross-domain data requests or because cross-domain data requests have been disabled, as discussed above. If cross-domain data requests are not supported then the request is dropped (act 306). A response indicating failure, an error, that cross-domain data requests are not supported, etc. can optionally be returned to the requester in act 306.

If, however, cross-domain data requests are supported, then a check is made as to whether the requested data is public (act 308). If the requested data is not public or if access to personalized data is not authorized, then a request denied response is generated (act 310) and sent to the application on the client device from which the request was received (act 312). The request denied response indicates to the application on the client device that the cross-domain data request was received but that the requested data is not available for cross-domain data requests. Alternatively, rather than generating and sending a request denied response to the requester in acts 310 and 312, the request can simply be dropped and no response sent to the application on the client device from which the request was received.

Returning to act 308, if the requested data is public (and optionally if access to personalized data is authorized), then a request allowed response including the requested data is generated (act 314) and sent to the application on the client device from which the request was received (act 316). The request allowed response returns the requested data to the application on the client device from which the request was received.

Thus, as can be seen in process 200 and 300, a cross-domain data request is sent from an application on the client device to the server. No authentication of the application or the client device is performed. Additionally, the request and response is a single-roundtrip exchange, with the request being sent in act 206 of FIG. 2 and the response with data being returned in act 316 of FIG. 3.

In one or more embodiments, the cross-domain data access is accomplished using at least two new HTTP (HyperText Transfer Protocol) headers: XDomainRequest and XDomainRequestAllowed. An additional header of XDomainRequestDenied can also optionally be used. Communication between the browser on the client device and the domain on the server device is performed using HTTP. The HTTP format defines message formats, and a header can be included within the messages. When the cross-domain data request is being sent to the target domain, the request is sent via an HTTP message with a header of “XDomainRequest”. When the target domain returns a request allowed message to the browser on the client device, the response is sent via an HTTP message with a header of “XDomainRequestAllowed”, and the “XDomainRequestAllowed” header can optionally be set to a value of “true”.

If cross-domain data requests are not supported by the target domain, or if the requested data is not available for cross-domain requests, then an HTTP message indicating failure of the request can be returned to the client device. This HTTP message can optionally include a header of “XDomainRequestDenied”, or a header of “XDomainRequestAllowed” set to a value of “false”. Alternatively, the browser can be configured with a timeout value, and after the amount of time indicated by this timeout value has elapsed after sending the cross-domain data request, the browser can assume that the request will not be allowed (whether due to the target domain not supporting cross-domain data requests or the requested data not being available for cross-domain requests).

In one or more embodiments, the cross-domain data request HTTP message includes the Host, Content-Type, Content-Length, and Referer headers. The Host header specifies the Internet host and port number of the resource being requested (the data being requested from the target domain). The Content-Type header indicates the media type of the message being sent. The Content-Length header indicates the size of the message being sent. The Referer header is an identifier of the client device (and/or Web browser) sending the request. HTTP, HTTP messages, and HTTP headers are well-known to those skilled in the art and thus will not be discussed further except as they pertain to the cross-domain data access techniques discussed herein.

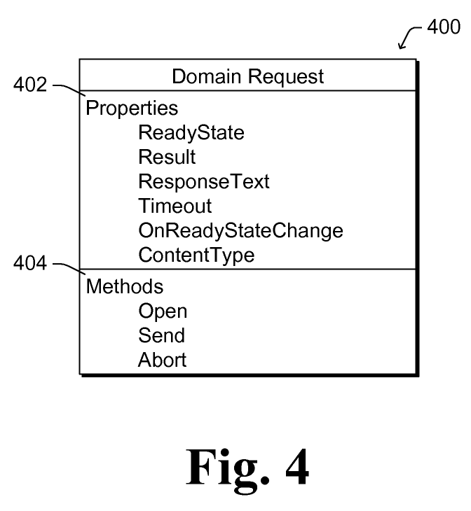

FIG. 4 illustrates an example Domain Request object 400 used in one or more embodiments. The Domain Request object 400 is typically used by the Web browser or another application on the client device when participating in the single-roundtrip exchange for cross-domain data access discussed herein. The Domain Request object 400 includes multiple properties 402 and multiple methods 404. It is to be appreciated that the properties 402 and methods 404 illustrated in FIG. 4 are only an example of exposing the cross-domain data access discussed herein programmatically. In other embodiments, additional properties and/or methods can be included in Domain Request object 400, or one or more of the properties and/or methods illustrated in FIG. 4 can be excluded from Domain Request object 400. Additionally, in other embodiments the properties and/or methods illustrated in FIG. 4 can have different names, different possible values, different parameters, and so forth.

Properties 402 include a ReadyState property, a Result property, a ResponseText property, a Timeout property, an OnReadyStateChange property, and a ContentType property. Methods 404 include an Open method, a Send method, and an Abort method. These properties and methods are discussed in more detail below.

The ReadyState property is of type long and is a read-only property. The ReadyState property indicates the progress state of the object. The possible values are:

0—Uninitialized

1—Open. The open( ) method has been successfully called

2—Headers Received. The headers have been received from the server.

3—Receiving. The server has started responding with data.

4—Complete. The data transfer is complete.

When the ReadyState property of the object changes, the OnReadyStateChange event is fired.

The Result property is of type long and is a read-only property. The Result property indicates the result code of the object after ReadyState is Receiving (a value of 3) or Complete (a value of 4). The possible values are:

0—No result. There is no result since the request hasn't been sent.

1—Success. The request was successful & response is available.

2—Error. The request failed, there is no further information about the failure.

3—Timeout. The request timed out.

The ResponseText property is of type BSTR (Basic string or binary string) and is a read-only property. The ResponseText property provides the response body received from the target domain. If the state is not Receiving or Complete, reading this property raises an exception. If there is no response body, reading this property returns an empty string. If the state is Receiving, reading this property returns the response received so far or the complete response body interpreted as a stream of characters.

The Timeout property is of type long and is a read/write property. The Timeout property sets or retrieves the timeout of the cross-domain data request. The Timeout property is invoked whenever the caller wants to change the default timeout of the response from the target domain. This takes a long which defines the timeout in milliseconds. The default timeout is the network level timeout of the platform. The timeout property is used to wait for a response after the send method is called.

The OnReadyStateChange property is a read/write property. The OnReadyStateChange property sets or retrieves the event handler for asynchronous cross-domain data requests. The OnReadyStateChange property is invoked whenever the ReadyState of the object changes. A Web page can remove an assigned handler by setting this value to NULL to enable garbage collection.

The ContentType property is of type BSTR and is a read/write property. The ContentType property sets or retrieves the content type of the data which will be sent to the target domain as the cross-domain data request when the request uses a POST HTTP method (discussed below).

The Open method has the following parameters which will be remembered by the object when the Open method is invoked, and the state of the object is changed to Open when the Open method is invoked. If the state of the object is not Uninitialized, this resets the ResponseText and Result properties to their initial values, and behaves as if abort( ) was invoked. The valid parameters are:
method (of type BSTR): The HTTP method of the request. The object supports the GET and POST HTTP methods. If the method parameter is not either of these, the Open method fails.
url (of type BSTR): A valid URL (Uniform Resource Locator) to which the request is sent to. This URL identifies the data of the target domain that is being requested.

The Send method sends a cross-domain data request to the URL identified in the Open method if the state of the object is Open. If the state of the object is not Open, then the Send method fails. The valid parameters of the Send method are:
data (of type BSTR): The data that is sent to the target domain as the cross-domain data request when the request uses a POST HTTP method.

The Abort method cancels any network activity for which the object is responsible, sets all properties to their initial values, and removes all event listeners. The Abort method does not have any parameters.

The Domain Request object 400 can be used by a Web page as follows. The Web page instantiates Domain Request object 400 and invokes the Open method. In invoking the Open method, the Web page provides an identifier of the data of the target domain that is being requested, as well as an indication of whether the request is to use the HTTP GET or HTTP POST method. The Send method is then invoked, causing the Web browser to send the cross-domain data request (the HTTP message with the XDomainRequest header) to the target domain. The Web page can then access properties 402 to monitor to the status of the request, and retrieve the requested data from the ResponseText property when it is received from the target domain.

The cross-domain data access is discussed herein primarily with reference to Web browsers. It is to be appreciated, however, that in other embodiments other applications besides Web browsers can use the cross-domain data access discussed herein. For example, other applications that do not directly display Web pages to users could employ the cross-domain data access discussed herein, such as applications that create Web pages, applications that access and store Web pages, applications that compile data for subsequent access by users, and so forth.

Additionally, it should be noted that Web browsers using the cross-domain data access discussed herein need not require user input to obtain the Web pages and/or may not display the Web pages to the user. For example, another application or component may request the particular Web pages, or the particular Web pages may be automatically retrieved by the Web browser. By way of another example, the Web browser may audibly play back (or alternatively store for later use) data from the Web page (as well as any data obtained via the cross-domain data access discussed herein).

Furthermore, the cross-domain data access is discussed herein primarily with reference to the Web browser on the client device reading data from the server device. It is to be appreciated, however, that other data accesses can be performed, such as causing data to be written at the server device. For example, the server device could also maintain a record of the various cross-domain data requests it receives (e.g., date and time of request, what data was requested, and so forth). This record could be maintained regardless of whether the requested data is returned to the requesting Web browser. By way of another example, the server device could maintain a record of received requests that were denied (e.g., a record of the data that was requested).

In addition, in one or more embodiments whether cross-domain data access is enabled on Web browser 108 of FIG. 1 can be a configurable option. This option could be configured by, for example, a user or system administrator of client device 102, another application executing on client device 102, and so forth. When enabled at Web browser 108, the cross-domain data access operates as discussed above. When disabled at Web browser 108, any requests for cross-domain data made by the Web page are ignored or dropped by Web browser 108. Web browser 108 optionally returns a failure or error indication to the Web page when the cross-domain data access is disabled to notify the Web page that the cross-domain data request could not be carried out.

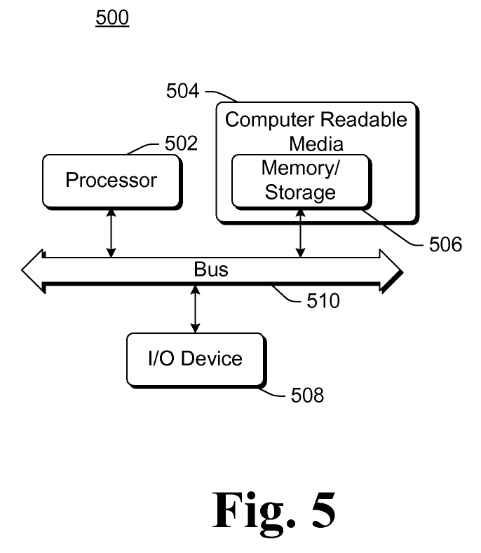

FIG. 5 illustrates an example computing device 500 that can be configured to implement the single-roundtrip exchange for cross-domain data access in accordance with one or more embodiments. One or more computing devices 500 can implement any of the techniques and processes discussed herein, and in one or more embodiments client device 102, each server 104, and each server 106 is a computing device 500.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or I/O device(s) 508 can be included as part of, or alternatively may be coupled to, computing device 500. Bus 510 represents one or more of any of several types of bus structures, including a memory bus or memory controller, a peripheral bus, an accelerated graphics port, and a processor or local bus using any of a variety of bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by processor 502. It is to be appreciated that different instructions can be stored in different components of computing device 500, such as in processor 502, in various cache memories of processor 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented in a computing device, the method comprising:
sending a cross-domain data request message to a target domain, the cross-domain data request message including a cross-domain data request header; and
receiving a cross-domain response message from the target domain, the cross-domain response message including both a cross-domain request allowed header and data requested by the cross-domain data request message, the target domain being different than a domain that includes a Web page that requested that the cross-domain data request message be sent.

2. A method as recited in claim 1, the cross-domain data request message and the cross-domain response message being a single-roundtrip anonymous exchange between the computing device and a server device hosting the target domain.

3. A method as recited in claim 2, the sending comprising sending the cross-domain data request message directly to the target domain from a Web browser of the computing device rather than via a mashup server acting as proxy.

4. A method as recited in claim 1, the cross-domain data request header comprising a XDomainRequest HTTP header, and the cross-domain request allowed header comprising a XDomainRequestAllowed HTTP header.

5. A method as recited in claim 1, further comprising:
the Web page having requested that the cross-domain data request message be sent by invoking a Send method of a Domain Request object, the Domain Request object including an Open method via which the Web page identified the data being requested.

6. A method as recited in claim 5, the Domain Request object further including a ResponseText property that receives the requested data from the target domain.

7. A method as recited in claim 1, the sending comprising sending the cross-domain data request message without any authentication information for the target domain to authenticate the computing device and without any authentication information for the target domain to authenticate the Web page.

8. A method as recited in claim 1, the sending comprising sending the cross-domain data request from a Web browser displaying the Web page.

9. A method, implemented in a computing device, the method comprising:
receiving an anonymous cross-domain data request message directly from an application on a client device, the anonymous cross-domain data request message including a cross-domain data request header; and
sending, to the client device, a cross-domain response message including both a cross-domain request allowed header and data requested by the anonymous cross-domain data request message only if cross-domain data requests are supported by the computing device and the data requested by the anonymous cross-domain data request message is available for cross-domain data requests.

10. A method as recited in claim 9, wherein the sending comprises sending the response to the application rather than to a proxy server operating on behalf of the application.

11. A method as recited in claim 9, the cross-domain data request header comprising a XDomainRequest HTTP header, and the cross-domain request allowed header comprising a XDomainRequestAllowed HTTP header.

12. A method as recited in claim 9, the cross-domain data request message and the cross-domain response message being a mutually consenting single-roundtrip exchange between the computing device and the client device.

13. A method as recited in claim 9, further comprising sending the cross-domain response message to the client device without authenticating the client device.

14. A method as recited in claim 9, further comprising dropping the cross-domain data request message and sending no response to the cross-domain data request message to the client device if cross-domain data requests are not supported by the computing device or if the data requested by the anonymous cross-domain data request message is not available for cross-domain data requests.

15. A method as recited in claim 9, further comprising sending no cross-domain response message to the client device or sending the cross-domain response message indicating failure of the request to the client device if cross-domain data requests are not supported by the computing device or if the data requested by the anonymous cross-domain data request message is not available for cross-domain data requests.

16. One or more computer storage media having stored thereon multiple instructions as part of a Web page that, when executed by one or more processors of a device, cause the one or more processors to:
instantiate a Domain Request object for cross-domain data access;
invoke an Open method of the Domain Request object to identify data to be requested from a first domain that is different than a second domain from which the Web page was obtained; and
invoke a Send method of the Domain Request object to request that a Web browser send a cross-domain data request to a server device hosting the first domain.

17. One or more computer storage media as recited in claim 16, the cross-domain data request being sent directly to the server device without a server device that hosts the second domain operating as a proxy server for the cross-domain data request.

18. One or more computer storage media as recited in claim 16, the Domain Request object including:
a ReadyState property that indicates a progress state of the Domain Request object;
a Result property that indicates a result code of the Domain Request object;
a ResponseText property that receives the requested data from the server device;
a Timeout property that indicates a timeout for the cross-domain data request;
an OnReadyStateChange property that indicates an event handler for the cross-domain data request; and
a ContentType property that indicates a content type of data that is to be sent in the cross-domain data request.

19. One or more computer storage media as recited in claim 16, the Domain Request object including no properties identifying the Web page.

20. One or more computer storage media as recited in claim 16, the Open method including:
a first parameter for identifying whether an HTTP GET or HTTP POST method is to be used for the cross-domain data request; and
a second parameter for identifying a Uniform Resource Locator of the data to be requested from the first domain.
